(19) United States
(12) Patent Application Publication
(10) Pub. No.: US 2010/0097054 A1
(43) Pub. Date: Apr. 22, 2010

(54) COUPLING DEVICE, PARTICULARLY FOR A SENSOR UNIT

(76) Inventors: Bernhard Kull, Remshalden (DE); Uwe Ehrhardt, Ostfildern (DE); Michael Spiessberger, Goeppingen (DE); Matthias Waibler, Remshalden-Hebsack (DE)

Correspondence Address: MICHAEL J. STRIKER, 103 EAST NECK ROAD, HUNTINGTON, NY, 11743, US

(21) Appl. No.: 12/527,017

(22) PCT Filed: Jul. 7, 2008
(86) PCT No.: PCT/EP08/58772

§ 371 Date: Aug. 13, 2009

(30) Foreign Application Priority Data
Sep. 3, 2007 (DE) 10 2007 041 849.5

(51) Int. Cl. G01B 7/30; F16H 1/06; F16D 1/076

(52) U.S. Cl. 324/207.25; 74/414

(57) ABSTRACT

The invention relates to a coupling device, particularly for a sensor unit, comprising at least one dog (30), which can be connected to a rotatable shaft, wherein the dog (30) has a dog toothing (24) at the front thereof, said toothing engaging in a rotor toothing (22) of the rotor (28) for transferring a rotating movement to a rotor (28), wherein the rotor toothing (22) and the dog toothing (24) are configured such that a clearance (20) is formed when the rotor toothing (22) and the dog toothing (24) are engaged in each other. The rotor toothing (22) and the dog toothing (24) are not in mechanical contact with each other in said clearance (20).

### BACKGROUND INFORMATION

The present invention is directed to a coupling device, particularly for a sensor unit, according to the general class of the independent claim. DE 450 249 makes known a toothed gearing having two simultaneously occurring tooth engagements. The gear wheels of the two gear-wheel pairs are displaced relative to one another in terms of the engagement position in such a manner that, in the case of one gear-wheel pair, one tooth is situated at the beginning of the engagement path, and, in the case of the other gear-wheel pair, one tooth is situated at the end of the engagement path. Contaminating particles situated between the gear wheels may result in undesired axial displacements.

The object of the present invention is to at least diminish the disadvantages described above. This object is achieved by the features of the independent claim.

### ADVANTAGES OF THE INVENTION

In the coupling device according to the present invention and having the features of the independent claim, the open space located between the tooth tip and the groove base is used to accommodate contaminating particles that may be present. Furthermore, the assembly of the two coupling parts, i.e. the rotor and the driving element, which are used to transfer torque is simplified via the automatic orientation that occurs during the assembly procedure. This may be realized, in particular, by slanting the tooth flank of the rotor toothing or the toothing of the driving element slightly by a certain angle relative to the perpendicular of the rotational axis. If the rotor is mounted on the driving element, this inclination ensures that the two coupling elements automatically orient themselves toward the rotational axis. At the same time, the necessary axial play is compensated for. Axial thrust forces on the torque-receiving side are prevented.

In an advantageous refinement it is provided that the rotor and/or driving element are supported on a bushing. The bushing could be composed, e.g. of a stainless steel, while the rotor is made of a plastic having good antifrictional properties, such as, particularly preferably, POM (polyoxymethylene, from the group of polyacetals). When a bushing is used to support the rotor, the coupling device is particularly suited for use to transfer the rotational speed of the wheel to a sensor unit for motorcycles. The spacer sleeve which is typically present on motorcycles may be used without the need to perform any additional significant structural changes.

In an advantageous development, the rotor toothing is composed of a softer material than is the toothing of the driving element. The driving element is typically connected directly to the rotating shaft, e.g. the front wheel of the motorcycle. To prevent the rotating shaft from becoming blocked if an error occurs, the type of material that is selected as described above ensures that the teeth become sheared off if blockage occurs. Given the material hardness that is selected, this would be the toothing of the rotor, which is normally connected to the sensor. This would not prevent, e.g. the front wheel of the motorcycle from continuing to rotate. Road traffic safety is increased as a result.

In an advantageous development, it is provided that the rotor is equipped with a device that influences a magnetic field, in particular a counting wheel. The coupling device is particularly well suited for use to transfer the rotational speed to be registered by a sensor. The counting wheel may be connected directly to the rotor, which ensures simple and, therefore, cost-favorable manufacture of the assembly.

In an advantageous development it is provided that a sensor registers the change in the magnetic field caused by the counting wheel. For this purpose, the sensor is mounted in a housing which is connected to the bushing. This makes it possible to realize a very compact sensor assembly together with the coupling device.

In an advantageous development, the open space is rectangular in design. In this open space, which is easy to manufacture, it is particularly easy to capture any contaminating particles that may be present, without affecting the functionality.

Further advantageous refinements result from the further dependent claims and the description.

### DETAILED DESCRIPTION OF THE EXEMPLARY EMBODIMENT

An exemplary embodiment of the coupling device, in particular for a sensor unit, is depicted in the drawing and is described in greater detail below.

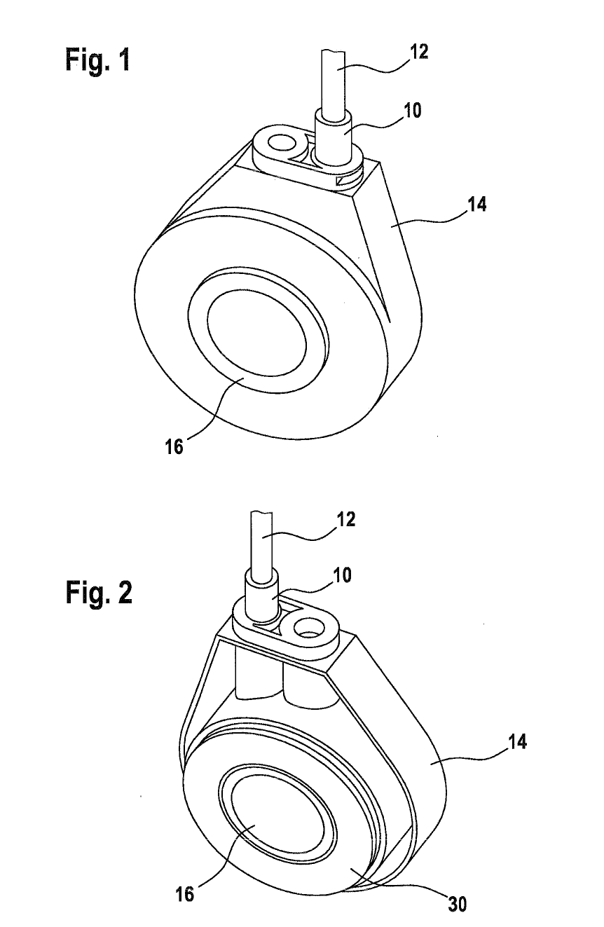

FIG. 1 shows a perspective view of a sensor unit having an integrated coupling device,

FIG. 2 shows the sensor device including coupling device shown in FIG. 1, as viewed from the back side,

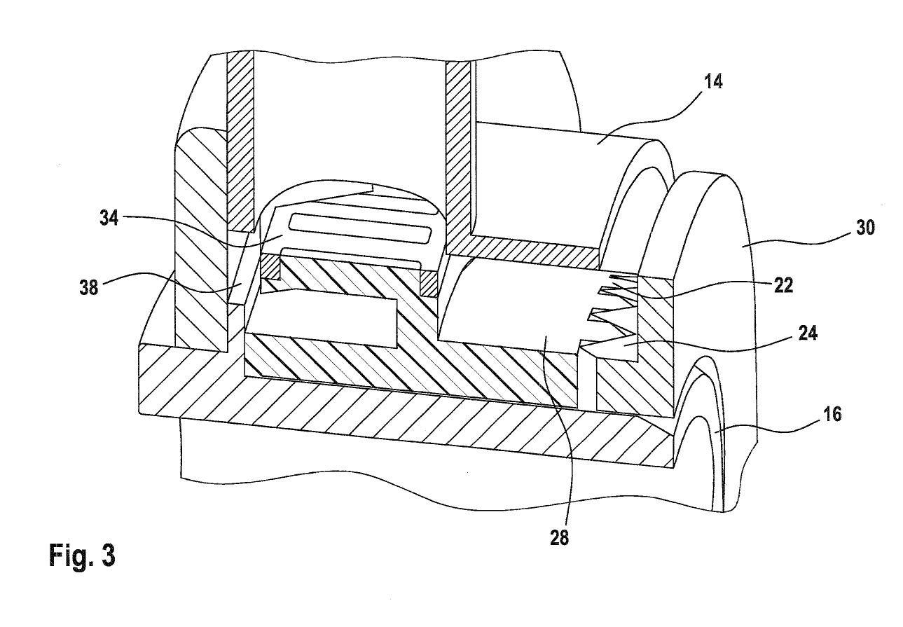

FIG. 3 shows a perspective half-sectional view through the coupling device,

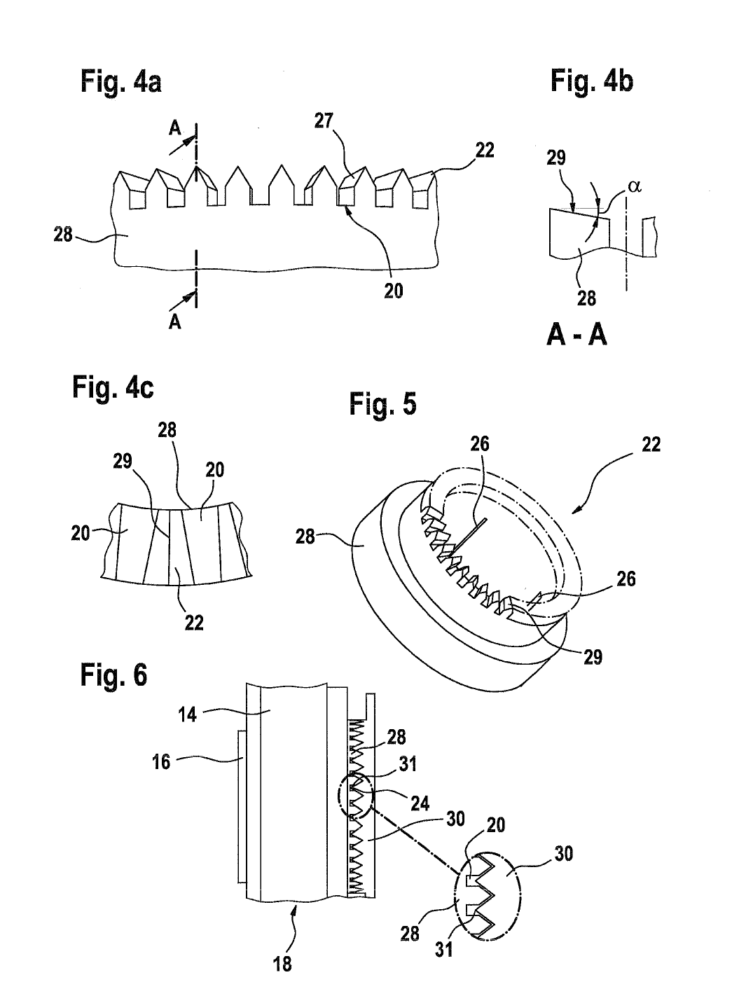

FIG. 4a shows a perspective partial view of the rotor,

FIG. 4b shows the cross section along intersection line A-A in FIG. 4a,

FIG. 4c shows a top view of a part of the toothing of the rotor,

FIG. 5 shows a perspective overall view of the rotor, and

FIG. 6 shows a side view of the coupling device in the installed state, in an enlarged detailed view.

A sensor 10 which may be connected using a cable 12 is accommodated in a housing 14. Housing 14 is connected to a bushing 16. As shown in FIG. 2, bushing 16 may be used as a bearing for a driving element 30, that is, driving element 30 may rotate relative to bushing 16. Driving element 30 is designed essentially as a tubular part which is limited on one side by a flange, while the other side transitions into a driving-element toothing 24. Driving-element toothing 24 has a triangular shape in the axial direction. It engages in a rotor toothing 22 of a rotor 28. Rotor 28 is also tubular in design and is supported by bushing 16. Bushing 16 includes a stop 38 for rotor 28 on the side opposite rotor toothing 22. Stop 38 is designed in the form of a flange. A cylindrical section on which a counting wheel 34 is situated is located radially further outward and is situated in the central region of rotor 28. Counting wheel 34 is essentially cage-shaped in design and includes openings situated in regular intervals in the circumferential direction. Bushing 16 is connected to housing 14 on the side opposite driving element 30. Sensor 10 may be situated in a cylindrical recess of housing 14; in the installed state, in the vicinity of counting wheel 34, sensor 10 detects changes to the magnetic field caused by counting wheel 34. The rotational speed or angle of rotation at which rotor 28, driving element 30, and the shaft connected thereto move relative to stationary sensor 10 is derived from the magnetic field that is detected by sensor 10. Housing 14 extends across the entire axial length of the coupling device and terminates relatively flush with the flange of driving element 30, as shown in FIG. 2.

FIG. 4a shows toothing 22 of rotor 28 in greater detail. Rotor teeth 22 transition axially into tips that are essentially triangular in shape. Instead of purely triangular teeth, the triangular tips transition in the direction toward the rotor body into axially parallel sections which therefore form an open space 20 which may be referred to as a groove base. Open space 20 is essentially rectangular in shape. Rotor teeth 22 are slanted relative to the perpendicular of the rotational axis of rotor 28, in the radial direction toward the rotational axis, by an angle α, as shown in FIG. 4b. FIG. 4b shows a cross-sectional view of two radially opposed tooth flanks 29 of rotor toothing 22.

Tooth flanks 29 are slanted at an angle a relative to the perpendicular of the rotational axis. As shown in the top view of toothing 22 in FIG. 4c, the circumference of rotor toothing 22 decreases with the radius. Recesses 26 are provided in rotor 28 or in driving element 30.

Entire rotor 28 which is essentially tubular in design is shown in the perspective view in FIG. 5. Two slot-shaped recesses 26 extend in the axial direction in the interior of rotor 28. Contaminating particles could also become deposited in recesses 26. The bearing of rotor 28 and bushing 16 could also be lubricated via recess 26.

As shown in FIGS. 3 and 6, rotor toothing 22 engages in driving-element toothing 24. Driving-element toothing 24 is matched exactly to the triangular part of rotor toothing 22. In contrast to rotor toothing 22, however, driving-element toothing 24 does not include a groove base or a rectangular open space 20. Instead, driving-element toothing 24 has a purely triangular shape in the axial direction. The inclination by angle α is also formed in a corresponding manner in driving-element toothing 24, where it is also used to automatically center rotor 28 and driving element 30. Tip 31 of driving element 30 comes to rest in open space 20, i.e. tip 31 of driving-element toothing 24 does not have direct mechanical contact with rotor toothing 22. Contaminating particles may also collect in open space 20; the contaminating particles are located, e.g. between rotor toothing 22 and driving-element toothing 24, and they reach open space 20 when rotor 28 and driving element 30 are assembled.

The coupling device shown, which is composed at least of rotor 28 and driving element 30, is preferably used to transfer a rotational motion to be detected by a sensor unit on a motorcycle. Driving element 30 is therefore connected to the front axle of the motorcycle. The parameters of the rotational motion, e.g. of the front axle or another axle, should be detected by sensor 10. For this purpose, the torque that is tapped by driving element 30 is transferred via driving-element toothing 24 and rotor toothing 22 to rotor 28. Counting wheel 34 which is composed of a material that influences a magnetic field, e.g. stainless steel or ferritic special steel, is mounted on rotor 28. Counting wheel 34 rotates together with rotor 28. Magnetic poles could also be located on counting wheel 34, the rotational motions of which result in a changed magnetic field. These magnetic poles which are located on counting wheel 34 could also be composed, e.g. of magnetic plastic. Based on the magnetic field that is detected, sensor 12 may ascertain the rotational motion or rotational speed of rotor 28. A sensor principle is also feasible according to which at least one magnetic field-producing element is provided in sensor 12, the magnetic field of which is changed by counting wheel 34 via the alternation between ferromagnetic material and non-ferromagnetic material as a function of the rotational motion.

Rotor 28 is preferably composed of a plastic that has very good antifrictional properties. For example, polyoxymethylene (POM) or other plastics from the group of polyacetals are particularly well-suited for this purpose. The good antifrictional properties are necessary since rotor 28 is supported on bushing 16 and therefore rotates relative to bushing 16. Furthermore, a material should be selected for rotor 28 that it is softer than the material used to make driving element 30. If the coupling should become blocked, the rotor toothing 22 would become sheared off relative to driving-element toothing 24 if rotor 28 would become blocked or jammed, since the wheel continues to move driving element 30. Blockage of the shaft and/or wheel may therefore be reliably prevented.

Driving element 30 is designed, e.g. as a deep-drawn part, or it is made of steel, and therefore has a greater strength than rotor 28 which is made of plastic. Spacer sleeve 16 which is used to support rotor 28 and driving element 30 is composed, e.g. of stainless steel.

Recesses 26 may be provided in rotor 28 or in driving element 30. Contaminating particles could also become deposited in recesses 26. The bearing could also be lubricated via recess 26. Thanks to the inwardly falling upper tooth flank 29, rotor 28 and driving element 30 are easier to install in the correct position. Tooth flanks 29 which are slanted at an angle a relative to the perpendicular of the rotational axis ensure self-centering toward the center point. Furthermore, pointed teeth 22, 24 ensure that joining may be carried out without assembly errors. From this perspective it is particularly advantageous that at least one set of teeth 22, 24 includes tips that directs the counter-teeth in the axial direction into the desired meshed position.

Another important aspect of the coupling device is that an open space 20 forms between rotor toothing 22 and driving-element toothing 24. This open space could also be formed by another geometry of toothing 22, 24. For example, the geometries of rotor toothing 22 and driving-element toothing 24 could be reversed, i.e. the groove base would be formed by an appropriate design of the driving-element toothing.

The coupling device for a sensor unit is preferably manufactured by first enclosing bushing 16—as an insertion piece—in a coating via injection molding. Housing 14 which is connected to bushing 16 is produced using an injection-moulding procedure. Polyamide 66 (PA66) is typically used as the plastic for housing 14. Rotor 30 is then placed on bushing 16. Next, sensor 10 is screwed into housing 14. In the final step, rotor 28 and driving element 30 are connected to one another.

The coupling device for a sensor unit described above is suited for use in particular to detect rotational speed on motorcycles. The application is not limited thereto, however. The device described above could be used to evaluate the coupling and rotational speed of basically any moving shafts.

What is claimed is:

1. A coupling device, particularly for a sensor unit, comprising at least one driving element (30) which may be connected to a rotatable shaft, and which includes a toothed driving section (24) on its front side, the toothed driving section (24) engaging in a rotor toothing (22) of the rotor (28) in order to transfer a rotary motion to a rotor (28), wherein
the rotor toothing (22) and the toothed driving section (24) are designed such that an open space (20) is formed when the rotor toothing (22) and the toothed driving section (24) are engaged in one other; the rotor toothing (22) and the toothed driving section (24) are not in mechanical contact with one other in this open space (20).

2. The device as recited in claim 1,
wherein
the rotor toothing (22) and/or the toothed driving section (24) include pointed tips which are preferably triangular in shape.

3. The device as recited in claim 1,
wherein
the open space (20) encloses at least one tip (31) of at least one of the pointed toothings (22, 24) in the engaged state.

4. The device as recited in claim 1,
wherein
rotors (28) and/or driving elements (30) are tubular in shape.

5. The device as recited in claim 1,
wherein
at least one top tooth flank (29) of the rotor toothing (22) and/or the toothed driving section (24) are/is slanted by an angle a relative to the perpendicular of the rotational axis of the rotor (28), toward the rotational axis of the rotor (28).

6. The device as recited in claim 1,
wherein
the rotors (28) and/or driving elements (30) are supported on a bushing (16).

7. The device as recited in claim 1,
wherein
the rotor toothing (22) is composed of a softer material than is the toothed driving section (24).

8. The device as recited in claim 1,
wherein
the rotor (28) is provided with a device that influences a magnetic field, preferably a counting wheel (34).

9. The device as recited in claim 1,
wherein
a sensor (10) is provided which detects a change in the magnetic field in order to register the rotational speed of the driving element (30).

10. The device as recited in claim 1,
wherein
the rotor (28) and/or the bushing (16) include(s) at least one recess (26).

11. The device as recited in claim 1
wherein
the open space (20) is groove-shaped and preferably rectangular in design.

12. The device as recited in claim 1,
wherein
the bushing (16) is connected to a housing (14).
